(19) United States
(12) Patent Application Publication
(10) Pub. No.: US 2020/0010699 A1
(43) Pub. Date: Jan. 9, 2020

(54) COATING FILM STRIPPING COMPOSITION AND METHOD FOR STRIPPING COATING FILM

(71) Applicant: NEOS CO., LTD., Kobe (JP)

(72) Inventors: Masato NISHIMOTO, Konan (JP); Takahiro UEDA, Konan (JP); Kazuya YOSHIMURA, Konan (JP)

(73) Assignee: NEOS CO., LTD., Kobe (JP)

(21) Appl. No.: 16/489,972

(22) PCT Filed: Feb. 13, 2018
(86) PCT No.: PCT/JP2018/004865

§ 371 Date: Aug. 29, 2019

(30) Foreign Application Priority Data
Mar. 28, 2017 (JP) 2017-062872

(51) Int. Cl. C09D 9/00

(52) U.S. Cl. CPC C09D 9/005

(57) ABSTRACT

This invention relates to a coating film remover composition comprising water, benzyl alcohol, and at least one kind of cellulose derivative, the coating film remover composition having a pH in the range of 5 to 9.

### TECHNICAL FIELD

The present invention relates to a coating film remover composition used in a step of removing old coating films of steel highway bridges, buildings, vehicles, aircrafts, and the like; as well as a method for removing a coating film.

### BACKGROUND ART

Repainting of a coating film of a bridge or the like is performed for the purpose of replacing the old coating film with a new, long-life coating film, so as to reduce the maintenance frequency; or to remove harmful substances (such as hexavalent chromium, lead, or PCB) contained in the old coating film.

Repainting to replace old coating films involves removal of the old coating films. This coating film removal has been carried out by physical removal methods, such as a blast method. However, the blast method has a concern in regards to increased waste and deterioration in the environment of workers and neighboring areas due to dust. To solve these problems, a method using a coating film remover containing, as a major agent, a chlorinated solvent, such as dichloromethane, has been carried out (Patent Document 1). However, since the use of chlorinated solvent as a coating film remover is now limited, considering its influence on humans and the environment, non-chlorine removers containing various solvents free of chlorinated solvent have recently been developed.

Patent Document 2 discloses a method using N-methylpyrrolidone as a non-chlorine coating film remover.

Patent Document 3 discloses a W/O-type emulsion composition comprising an oil phase containing ethylcellulose and a solvent that can swell the ethylcellulose, and an aqueous phase containing a water-soluble polymer. This emulsion composition ensures excellent emulsion stability by containing the ethylcellulose and the water-soluble polymer; however, this composition is used as a cosmetic, and the invention does not relate to coating film removal.

### CITATION LIST

### Patent Documents

### Patent Document 1: JPHS-171076A

### Patent Document 2: JPHS-279607A

### Patent Document 3: Japanese Patent No. 3549995

### SUMMARY OF INVENTION

### Technical Problem

Although a water-free, non-chlorine coating film remover ensures high removal performance, it is problematic in that it may cause fires and complications in the washing step after the removal. Further, since it contains a large amount of toxic solvents, it is also problematic in terms of worker safety.

A major object of the present invention is to provide a water-based, coating-type coating film remover composition that is capable of reducing the risk of fire, health hazard, and the like during the coating film removal work, and that can ensure removal performance equal to or greater than that of a solvent-based remover; as well as a method for removing a coating film.

### Solution to Problem

The inventors of the present invention attempted to solve the above problem by emulsifying an aromatic alcohol-based solvent effective for coating film removal using a surfactant, such as polyoxyethylene alkylether; however, a sufficient emulsifying property was not obtained. However, the inventors found that by using a cellulose derivative, a sufficient emulsifying property was obtained, and the viscosity was increased. The present invention provides a coating film remover composition that can improve the coating film removal property and the application workability, and reduce the risk of fire by using a cellulose derivative; as well as a method for removing a coating film.

Item 1. A coating film remover composition, comprising water, benzyl alcohol, and at least one kind of cellulose derivative, the coating film remover composition having a pH in the range of 5 to 9.
Item 2. The composition according to Item 1, wherein the mass ratio of benzyl alcohol to water (mass of benzyl alcohol/mass of water) is in the range of 0.6 to 4.8.
Item 3. The composition according to Item 1 or 2, wherein the cellulose derivative is at least one member selected from the group consisting of methylcellulose, hydroxyethylcellulose, hydroxypropyl methylcellulose, butyl cellulose, and propyl cellulose.
Item 4. The composition according to any one of Items 1 to 3, wherein the amount of the cellulose derivative is 0.5 to 3 wt %, based on the entire amount.
Item 5. The composition according to any one of Items 1 to 4, wherein the composition has a viscosity in the range of 3,000 to 110,000 mPa·s at room temperature.
Item 6. A method for removing a coating film, comprising applying the coating film remover composition according to any one of Items 1 to 5 to a coating film, and removing the coating film.

### Advantageous Effects of Invention

Due to the water contained therein, the coating film remover composition of the present invention can greatly reduce the risk of fire. Further, the cellulose derivative used in the composition has a viscosity-improving action, in addition to the emulsification property; therefore, the composition does not easily flow down after the application. Further, since the composition forms a film on the coated surface after it permeates through the coating film, the composition is prevented from drying, thereby reducing the removal time.

### DESCRIPTION OF EMBODIMENTS

In the present invention, benzyl alcohol is used as an oil phase of the remover composition. The mass ratio of the benzyl alcohol to water (benzyl alcohol/water) is in the range of 0.6 to 4.8, preferably 0.8 to 3.0. When the mass ratio of benzyl alcohol to water falls within the range described above, the composition has an excellent emulsification stability and viscosity, and is free from the risk of fire.

Examples of the cellulose derivatives used in the present invention include methylcellulose, ethylcellulose, hydroxypropyl cellulose, hydroxyethyl cellulose, hydroxypropyl methylcellulose, butyl cellulose, propyl cellulose, and the like.

The amount of the benzyl alcohol used in the present invention is preferably 30 to 90 wt %, more preferably 35 to 85 wt %, further preferably 40 to 80 wt %, particularly preferably 45 to 75 wt %, based on the entire amount, i.e., 100 wt %, of the coating film remover composition.

The amount of the water used in the present invention is preferably 10 to 70 wt %, more preferably 15 to 60 wt %, further preferably 20 to 50 wt %, particularly preferably 25 to 40 wt %, based on the entire amount, i.e., 100 wt %, of the coating film remover composition.

The amount of the cellulose derivative used in the present invention is 0.3 to 5 wt %, preferably 0.4 to 4 wt %, more preferably 0.5 to 3.5 wt %, further preferably 0.5 to 3 wt %, particularly preferably 1 to 3 wt %, most particularly preferably 1 to 2 wt %, based on the entire amount, i.e., 100 wt %, of the coating film remover composition. When the amount of the cellulose derivative falls within the range described above, the composition has excellent emulsification stability.

In the present invention, only one kind of cellulose derivative may be used alone, or two or more kinds of cellulose derivatives may be used in combination.

The viscosity of the coating film remover composition of the present invention at room temperature is generally about 3,000 to 110,000 mPa·s, preferably about 3,000 to 70,000 mPa·s, more preferably about 4,000 to 50,000 mPa·s, further more preferably about 4,000 to 40,000 mPa·s. By setting the viscosity within the above range, the coating film remover composition does not flow down after the application, thereby ensuring excellent application workability. The viscosity can be measured by a Brookfield viscometer.

In addition to the above components, a pH adjuster (such as acetic acid and like fatty acids, phosphoric acid, caustic soda, or caustic potash) for making the coating film remover composition acidic or alkaline; a preservative; a chelating agent; and the like may be appropriately added. The pH range in which the cellulose derivative contained in the coating film remover composition of the present invention is not hydrolyzed is about 5 to 9, preferably about 5 to 8, more preferably about 6 to 8.

The objects to which the coating film remover composition of the present invention is applied include coating films of steel constructions such as steel highway bridge; and coating films of building surfaces, such as exterior walls. The coating film remover composition of the present invention is useful for the removal of coating films mainly containing melamine, acrylic, phthalic acid, lacquer, urethane, or epoxy resin.

The application amount of the coating film remover composition of the present invention is preferably about 0.5 to 2 kg/m², more preferably about 0.5 to 1 kg/m². For example, the coating film remover composition of the present invention may be applied to a coating film, and the coating film may be removed 12 to 48 hours, preferably about 24 hours, after the application using a scraper or the like. The application of the coating film remover composition to a coating film may be performed by way of a spray, roller, brush, or the like.

When the coating film is removed from the object, it is first detached from the coated object, and then removed from the object. Therefore, the coating film can be easily discarded by being contained in a disposal bag or the like, and harmful substances will therefore not be scattered.

### EXAMPLES

The present invention is specifically described below with reference to Examples. However, the present invention is not limited to these Examples.

In the Examples and Comparative Examples described below, the following cellulose derivative, polyvinyl alcohol, and polyvinyl pyrrolidone were used.

### Cellulose Derivative

Cellulose Derivative 1: produced by Shin-Etsu Chemical Co., Ltd. Metolose SM-400
Cellulose Derivative 2: produced by Shin-Etsu Chemical Co., Ltd. Metolose 60SH-4000
Cellulose Derivative 3: produced by Shin-Etsu Chemical Co., Ltd. Metolose 65SH-4000
Cellulose Derivative 4: produced by Shin-Etsu Chemical Co., Ltd. Metolose 90SH-4000
Cellulose Derivative 5: produced by Shin-Etsu Chemical Co., Ltd. Metolose SM-4000

### Polyvinyl Pyrrolidone

Pitzcol K-90, produced by DKS Co. Ltd.

### Polyvinyl Alcohol

Kuraray Poval PVA105, produced by Kuraray Co., Ltd.

### Examples 1 to 11 and Comparative Examples 1 to 5

### Emulsification Test and Viscosity Measurement

Metolose SM-400 (2 g) was completely dissolved in 18 g of water. 80 g of benzyl alcohol was placed in the resulting solution and the mixture was stirred for an hour, thereby preparing a coating film remover composition of Example 1. The coating film remover compositions of Examples 2 to 11 and Comparative Examples 1 to 5 were prepared in a similar manner according to the proportions shown in Table 1. The state of the liquid was confirmed by visual inspection 24 hours after the preparation, thereby evaluating the emulsification state (evaluation of emulsification). The evaluation criteria are as follows.
◯: The milky-white color was maintained.
x: The liquid underwent layer separation.

The viscosity of each remover composition obtained in Examples 1 to 11 was measured using a Brookfield viscometer. Further, the pH of each remover composition of Examples 1 to 11 was measured using a pH-test paper.
Coating Film Removal Test

Each remover composition thus prepared in the emulsification test was applied to two kinds of test plates (Coated Article 1 and Coated Article 2). After a predetermined amount of time passed, the surface of each test plate was rubbed with a scraper so as to examine whether the coating can be removed. The evaluation criteria are as follows.
◯: The coating film could be removed.
x: The coating film could not be removed.

### Coated Article 1 (Undercoating with a Super-thick-film-type Epoxy Resin Coating Composition for Buildings)

A coating composition (Eponics H, produced by Dai Nippon Toryo Co., Ltd.) containing epoxy resin as a major agent and modified aliphatic polyamine as a curing agent was applied to a cold-rolled steel sheet (SPCC-SD) flat plate (0.8×25×50 mm) to a thickness of 230 μm using a brush. Thereafter, the test plate was allowed to stand at room temperature for three days, thereby curing the coating film. Each coating film remover composition was applied to the resulting coating film with a brush, and the test plate was allowed to stand for 24 hours. Thereafter, evaluation was performed to examine whether the coating film could be removed (removal test results (epoxy resin)). Tables 1 to 4 show the results.

### Coated Article 2 (Phthalic Acid-based Resin)

A long-oil phthalic acid resin coating composition (Green Suboid, produced by Dai Nippon Toryo Co., Ltd.) was applied to a cold-rolled steel sheet (SPCC-SD) flat plate (0.8×25×50 mm) to a thickness of 60 μm using a brush. Thereafter, the test plate was allowed to stand at room temperature for three days, thereby completely curing the coating film. Each coating film remover composition was applied to the resulting coating film with a brush, and the test plate was allowed to stand for 24 hours. Thereafter, evaluation was performed to examine whether the coating film could be removed (removal test results (phthalic acid-based resin)). Tables 1 to 4 show the results.

TABLE 1

| | Example 1 | Example 2 | Example 3 | Example 4 | Example 5 | Example 6 |
|---|---|---|---|---|---|---|
| Benzyl Alcohol | 80 | 60 | 50 | 75 | 40 | 70 |
| Water | 18 | 38 | 49 | 22 | 59.5 | 29 |
| Cellulose Derivative 1 | 2 | 2 | 1 | 3 | 0.5 | |
| Cellulose Derivative 2 | | | | | | 1 |
| Cellulose Derivative 3 | | | | | | |
| Cellulose Derivative 4 | | | | | | |
| Cellulose Derivative 5 | | | | | | |
| Polyvinyl Pyrrolidone | | | | | | |
| Polyvinyl Alcohol | | | | | | |
| Evaluation of | ◯ | ◯ | ◯ | ◯ | ◯ | ◯ |
| Emulsification | | | | | | |
| pH | 7 | 7 | 7 | 7 | 7 | 7 |
| Viscosity (mPa · s) | 4000 | 16540 | 5350 | 29750 | 3250 | 4350 |
| Removal Test Results | ◯ | ◯ | ◯ | ◯ | ◯ | ◯ |
| (Epoxy Resin) | | | | | | |
| Removal Test Results | ◯ | ◯ | ◯ | ◯ | ◯ | ◯ |
| (Phthalic Acid-Based | | | | | | |
| Resin) | | | | | | |

TABLE 2

| | | | | Example | Example | Example | Example |
|---|---|---|---|---|---|---|---|
| | Example 7 | Example 8 | Example 9 | 10 | 11 | 12 | 13 |
| Benzyl Alcohol | 50 | 80 | 60 | 80 | 40 | 60 | 60 |
| Water | 49 | 18 | 39 | 18 | 59 | 38.4 | 38.3 |
| Cellulose | | | | | | | |
| Derivative 1 | | | | | | | |
| Cellulose | 1 | 2 | | | | | |
| Derivative 2 | | | | | | | |
| Cellulose | | | 1 | 2 | | | |
| Derivative 3 | | | | | | | |
| Cellulose | | | | | 1 | | |
| Derivative 4 | | | | | | | |
| Cellulose | | | | | | 1.6 | 1.7 |
| Derivative 5 | | | | | | | |
| Polyvinyl | | | | | | | |
| Pyrrolidone | | | | | | | |
| Polyvinyl Alcohol | | | | | | | |
| Evaluation of | ◯ | ◯ | ◯ | ◯ | ◯ | ◯ | ◯ |
| Emulsification | | | | | | | |
| pH | 7 | 7 | 7 | 7 | 7 | 7 | 7 |
| Viscosity (mPa · s) | 18600 | 29250 | 16000 | 33000 | 5250 | 67600 | 104400 |
| Removal Test | ◯ | ◯ | ◯ | ◯ | ◯ | ◯ | ◯ |
| Results (Epoxy | | | | | | | |
| Resin) | | | | | | | |
| Removal Test | ◯ | ◯ | ◯ | ◯ | ◯ | ◯ | ◯ |
| Results (Phthalic | | | | | | | |
| Acid-Based Resin) | | | | | | | |

TABLE 3

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| Benzyl Alcohol | 30 | 30 | 60 | 70 | 60 | 50 |
| Water | 69 | 69 | 36 | 39.9 | 59 | 48 |
| Cellulose | 1 | | 4 | 0.1 | | |
| Derivative 1 | | | | | | |
| Cellulose | | 1 | | | | |
| Derivative 2 | | | | | | |
| Cellulose | | | | | | |
| Derivative 3 | | | | | | |
| Cellulose | | | | | | |
| Derivative 4 | | | | | | |
| Cellulose | | | | | | |
| Derivative 5 | | | | | | |
| Polyvinyl | | | | | 1 | |
| Pyrrolidone | | | | | | |
| Polyvinyl | | | | | | 2 |
| Alcohol | | | | | | |
| Evaluation of | ◯ | X | X | X | X | X |
| Emulsification | | | | | | |
| pH | — | — | — | — | — | — |
| Viscosity | | — | — | — | — | — |
| (mPa · s) | | | | | | |
| Removal Test | X | X | X | X | X | X |
| Results (Epoxy | | | | | | |
| Resin) | | | | | | |
| Removal Test | X | X | X | X | X | X |
| Results | | | | | | |
| (Phthalic | | | | | | |
| Acid-Based | | | | | | |
| Resin) | | | | | | |

TABLE 4

| | Comparative | Comparative | Comparative | Comparative | Comparative |
|---|---|---|---|---|---|
| | Example 7 | Example 8 | Example 9 | Example 10 | Example 11 |
| Benzyl Alcohol | 50 | 50 | 50 | 50 | 50 |
| Water | 45 | 45 | 45 | 45 | 45 |
| Polyoxyethylene | 5 | | | | |
| Dilaurate | | | | | |
| Polyoxyethylene | | 5 | | | |
| Monooleate | | | | | |
| Linear Alkyl | | | 5 | | |
| Benzene Sodium | | | | | |
| Sulfonate | | | | | |
| Polyoxyethylene | | | | 5 | |
| Lauryl Ether | | | | | |
| Polyoxyethylene | | | | | 5 |
| Sorbitan | | | | | |
| Monooleate | | | | | |
| Evaluation of | x | x | x | x | x |
| Emulsification | | | | | |

Polyoxyethylene Dilaurate: Ionet DL-200, HLB: 6.6, produced by Sanyo Chemical Industries, Ltd.
Polyoxyethylene Monooleate: Ionet DO-600, HLB: 10.4, produced by Sanyo Chemical Industries, Ltd.
Linear Alkyl Benzene Sodium Sulfonate: Neo-Gen S-20F, produced by DKS Co. Ltd.
Polyoxyethylene Lauryl Ether: Emulmin NL-110, HLB: 14.4, produced by Kao Corporation
Polyoxyethylene Sorbitan Monooleate Rheodol TW-O106V, HLB: 10.0, produced by Kao Corporation

1. A coating film remover composition, comprising water, benzyl alcohol, and at least one kind of cellulose derivative, the coating film remover composition having a pH in the range of 5 to 9, the amount of the cellulose derivative being 0.5 to 5 wt %, based on the entire amount.

2. The composition according to claim 1, wherein the mass ratio of benzyl alcohol to water (mass of benzyl alcohol/mass of water) is in the range of 0.6 to 4.8.

3. The composition according to claim 2, wherein the cellulose derivative is at least one member selected from the group consisting of methylcellulose, hydroxyethylcellulose, hydroxypropyl methylcellulose, butyl cellulose, and propyl cellulose.

4. The composition according to claim 3, wherein the amount of the cellulose derivative is 0.5 to 3 wt %, based on the entire amount.

5. The composition according to claim 4, wherein the composition has a viscosity in the range of 3,000 to 110,000 mPa·s at room temperature.

6. (canceled)

7. The composition according to claim 1, wherein the cellulose derivative is at least one member selected from the group consisting of methylcellulose, hydroxyethylcellulose, hydroxypropyl methylcellulose, butyl cellulose, and propyl cellulose.

8. The composition according to claim 1, wherein the amount of the cellulose derivative is 0.5 to 3 wt %, based on the entire amount.

9. The composition according to claim 1, wherein the composition has a viscosity in the range of 3,000 to 110,000 mPa·s at room temperature.

10. A method for removing a coating film, comprising applying the coating film remover composition according to claim 1 to a coating film, and removing the coating film.

11. The method for removing a coating film according to claim 10, wherein the coating film comprises melamine, acrylic, phthalic acid, lacquer, urethane, or epoxy resin.

12. A method for removing a coating film, comprising applying the coating film remover composition according to claim 5 to a coating film, and removing the coating film.

13. The method for removing a coating film according to claim 12, wherein the coating film comprises melamine, acrylic, phthalic acid, lacquer, urethane, or epoxy resin.

14. A method for removing a coating film, comprising applying the coating film remover composition according to claim 7 to a coating film, and removing the coating film.

15. The method for removing a coating film according to claim 14, wherein the coating film comprises melamine, acrylic, phthalic acid, lacquer, urethane, or epoxy resin.

16. A method for removing a coating film, comprising applying the coating film remover composition according to claim 8 to a coating film, and removing the coating film.

17. The method for removing a coating film according to claim 16, wherein the coating film comprises melamine, acrylic, phthalic acid, lacquer, urethane, or epoxy resin.

18. A method for removing a coating film, comprising applying the coating film remover composition according to claim 9 to a coating film, and removing the coating film.

19. The method for removing a coating film according to claim 18, wherein the coating film comprises melamine, acrylic, phthalic acid, lacquer, urethane, or epoxy resin.
